(19) United States
(12) Patent Application Publication
(10) Pub. No.: US 2026/0302382 A1
(43) Pub. Date: Oct. 1, 2026

(54) BATTERY WITH SAFETY SHUTDOWN APPARATUS AND METHODS

(71) Applicant: Medtronic, Inc., Minneapolis, MN (US)

(72) Inventors: Laura E. McCalla, Brossard (CA); Marissa A. Carey, St. Paul, MN (US); Eric I. Hanson, Maple Grove, MN (US); Lu Yu, Shakopee, MN (US); Prabhakar A. Tamirisa, Brooklyn Park, MN (US); Parthasarathy M. Gomadam, Plymouth, MN (US); Erik J. Hovland, Minnetonka, MN (US)

(21) Appl. No.: 19/478,863

(22) PCT Filed: Mar. 26, 2024
(86) PCT No.: PCT/IB2024/052889

§ 371 Date: Oct. 27, 2025

Related U.S. Application Data
(60) Provisional application No. 63/461,650, filed on Apr. 25, 2023.

(51) Int. Cl. H01M 10/42

(52) U.S. Cl. CPC H01M 10/4235; H01M 2200/10

(57) ABSTRACT

Batteries that include a shutdown initiator that is activated in response to a temperature of the battery exceeding a threshold temperature and methods of use thereof. The shutdown initiator may inhibit ion transport between a cathode electrode and an anode electrode of the battery. The battery may include a barrier between the shutdown initiator and a solution of the battery.

This application claims the benefit of U.S. Provisional Patent Application Ser. No. 63/461,650, filed Apr. 25, 2023, the entire content of which is incorporated herein by reference.

### FIELD

The present disclosure relates to, among other things, batteries and electrochemical cells.

### TECHNICAL BACKGROUND

Batteries or electrochemical cells are generally used to provide power to devices when wired connections to external power sources may be undesirable or inconvenient. For example, batteries may be used in portable devices such as laptops, mobile phones, in implantable medical devices, or medical tools where constant connection to external power sources may be cumbersome or excessively restrictive. For many battery-powered tools and devices, the ability to be both cordless and rechargeable can be beneficial. However, such battery powered tools and devices may be used in or subjected to conditions that approach or exceed operating limits intended to prevent failure of the batteries that may result in damage to the tools or devices as well as other potential hazards.

For example, to be safely used in an operating room, a battery-powered surgical tool must be sterile. In some cases, the surgical tool may be sterilized without the battery followed by aseptic transfer of the battery into the sterile tool. These aseptic transfer methods require several people and a sterile field that must not be broken. In a different method, the battery-powered surgical tool containing the battery is sterilized using hydrogen peroxide gas plasma at low temperature (temperatures less than 50 degrees Celsius). Although the battery-powered surgical tool can be sterilized with the battery already inserted, the hydrogen peroxide gas plasma method requires specialized equipment, such as a STERRAD instrument (available from Advanced Sterilization Products).

### BRIEF SUMMARY

As described herein, thermal runaway protection of a battery may be achieved by including a shutdown initiator to inhibit ion transfer between a cathode electrode and an anode electrode in response to conditions that may precede thermal runaway. Batteries may include an electrode assembly and an ion transport medium disposed in a housing. In general, the shutdown initiator may initiate a reaction or process that inhibits or reduces ion transfer between the cathode electrode and the anode electrode prior to thermal runaway of the battery being initiated. Accordingly, a battery that includes a shutdown initiator as described herein may prevent thermal runaway of the battery even in conditions that may present a risk of thermal runaway for typical batteries.

In one aspect, the present disclosure describes a battery that includes a housing, an electrode assembly, a solution disposed in the housing; and reservoir disposed in the housing. The electrode assembly includes a cathode electrode; an anode electrode; and a separator arranged between the cathode electrode and the anode electrode to prevent direct contact between the cathode electrode and the anode electrode. The solution includes an electrolyte to facilitate ion transport between the cathode electrode and the anode electrode. The reservoir includes a shutdown initiator and a barrier. The shutdown initiator is configured to inhibit ion transport between the cathode electrode and the anode electrode upon contact with the solution. The barrier is disposed between the shutdown initiator and the solution to separate the shutdown initiator from the solution. The barrier is configured to release the shutdown initiator into the solution in response to a temperature of the barrier exceeding a threshold temperature.

In another aspect, the present disclosure describes a battery that includes a housing, an electrode assembly, a solution disposed in the housing; and a shutdown initiator disposed in the housing. The electrode assembly includes a cathode electrode; an anode electrode; and a separator arranged between the cathode electrode and the anode electrode to prevent direct contact between the cathode electrode and the anode electrode. The solution includes an electrolyte to facilitate ion transport between the cathode electrode and the anode electrode. The shutdown initiator disposed in the housing is configured to inhibit ion transport between the cathode electrode and the anode electrode in response to a temperature of the battery exceeding a threshold temperature.

In some embodiments, the threshold temperature is at least 150 degrees Celsius.

In some embodiments, the shutdown initiator comprising an oxidizing agent. In some such embodiments, the oxidizing agent is a fluorinating agent.

In some embodiments, the shutdown initiator comprises a gelling agent.

In another aspect, the present disclosure describes a method of using anyone of the batteries of the present disclosure. The method includes heating a battery above the threshold temperature; releasing the shutdown initiator into the solution in response to a temperature of the battery exceeding the threshold temperature; and inhibiting ion transport between the cathode electrode and the anode electrode using the shutdown initiator in response to the shutdown initiator being released into the solution.

In one aspect, the present disclosure describes a battery that includes a housing, an electrode assembly, a solution disposed in the housing; and reservoir disposed in the housing. The electrode assembly includes a cathode electrode; an anode electrode; and a separator arranged between the cathode electrode and the anode electrode to prevent direct contact between the cathode electrode and the anode electrode. The solution includes an electrolyte to facilitate ion transport between the cathode electrode and the anode electrode. The reservoir includes a shutdown initiator and a barrier. The shutdown initiator is configured to inhibit ion transport between the cathode electrode and the anode electrode upon contact with the solution. The barrier is disposed between the shutdown initiator and the solution to separate the shutdown initiator from the solution. The barrier is configured to release the shutdown initiator into the solution in response to a temperature of the barrier exceeding a threshold temperature.

In another aspect, the present disclosure describes a battery that includes a housing, an electrode assembly, a solution disposed in the housing; and a shutdown initiator disposed in the housing. The electrode assembly includes a cathode electrode; an anode electrode; and a separator arranged between the cathode electrode and the anode electrode to prevent direct contact between the cathode electrode and the anode electrode. The solution includes an electrolyte to facilitate ion transport between the cathode electrode and the anode electrode. The shutdown initiator disposed in the housing is configured to inhibit ion transport between the cathode electrode and the anode electrode in response to a temperature of the battery exceeding a threshold temperature.

In some embodiments, the threshold temperature is at least 150 degrees Celsius.

In some embodiments, the shutdown initiator comprising an oxidizing agent. In some such embodiments, the oxidizing agent is a fluorinating agent.

In some embodiments, the shutdown initiator comprises a gelling agent.

In another aspect, the present disclosure describes a method of using anyone of the batteries of the present disclosure. The method includes heating a battery above the threshold temperature; releasing the shutdown initiator into the solution in response to a temperature of the battery exceeding the threshold temperature; and inhibiting ion transport between the cathode electrode and the anode electrode using the shutdown initiator in response to the shutdown initiator being released into the solution.

Advantages and additional features of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

### BRIEF DESCRIPTION OF THE DRAWINGS

The following detailed description of specific embodiments of the present disclosure can be best understood when read in conjunction with the following drawings, in which:

FIG. 1 is a schematic block diagram of an embodiment of a battery that includes a shutdown initiator;

FIG. 2 is a cross-sectional side view of one embodiment of the battery of FIG. 1;

FIG. 3 is a cross-sectional side view of another embodiment of the battery of FIG. 1;

FIG. 4 is a cross-sectional side view of yet another embodiment of the battery of FIG. 1;

FIG. 5 is a schematic flow diagram of a method for inhibiting ion transfer in a battery.

### DETAILED DESCRIPTION

Reference will now be made in greater detail to various embodiments of the subject matter of the present disclosure, some embodiments of which are illustrated in the accompanying drawings. Like numbers used in the figures refer to like components and steps. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components.

Batteries or electrochemical cells may be used to allow tools or devices to be both cordless and rechargeable. While many uses for cordless tools and devices readily accommodate typical operational conditions that may prevent battery failure, batteries that can be exposed to conditions that may lead to battery failure without damage to the tools or devices and other potential hazards may be desirable. In particular, batteries that can fail gracefully such that battery failure does not result in thermal runaway may can reduce damage or hazards that may be caused by thermal runaway and expand acceptable use conditions for batteries.

Batteries or electrochemical cells as described herein may include a shutdown initiator disposed in a housing of the battery. The shutdown initiator may inhibit ion transfer between electrodes of the batteries in response to a temperature of the battery exceeding a threshold temperature. As used herein, the term “inhibit ion transfer” and grammatical variants thereof (e.g., “inhibition of ion transfer,” “inhibiting of ion transfer,” “ion transfer inhibition,” etc.) may refer to a reduction in the ion transfer capability such that any ion transfer capability that may remain is insufficient to maintain or increase a temperature of the battery. In other words, the shutdown initiator, upon activation, may reduce an ion transfer capability of the battery such any heat generated as a result of ion transfer is incapable of maintaining or further increasing the temperature of the battery. Accordingly, inhibition of ion transfer between the electrodes of the batteries may prevent thermal runaway of the batteries from occurring as well as any damage or hazards that may result therefrom.

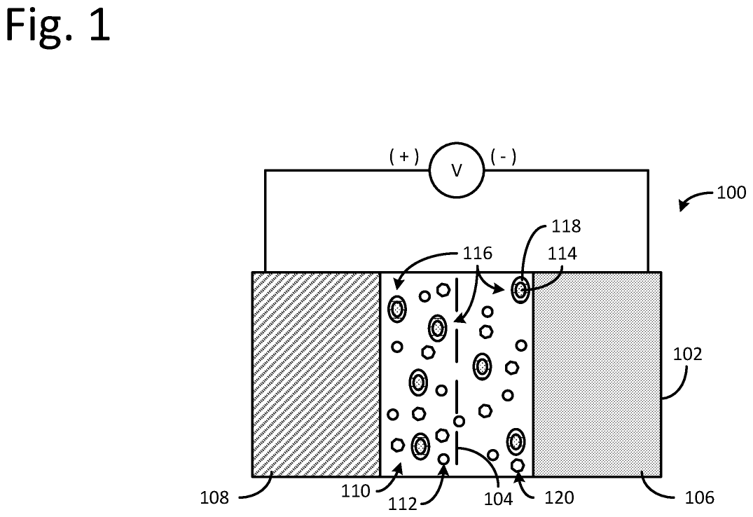

FIG. 1 shows a schematic representation of a battery 100. The battery 100 includes a housing 102 and an electrode assembly disposed in the housing 102. The electrode assembly may include at least one electrode pair and a separator 104 disposed between the electrode pair (e.g., a polymeric microporous separator, indicated by the dashed line). The electrode pair may include an anode electrode 106 (e.g., a negative electrode) and a cathode electrode 108 (e.g., a positive electrode). The battery 100 also includes a solution 110 disposed in the housing 102 that includes an electrolyte 112 to facilitate ion transfer between the anode electrode 106 and the cathode electrode 108. Still further, the battery 100 includes a shutdown initiator 114 to inhibit ion transport between the cathode electrode and the anode electrode in response to a temperature of the battery exceeding a threshold temperature.

The battery 100 may include any suitable chemistry. The chemistry of the battery 100 may include, for example, lithium-metal, lithium-ion, lithium polymer, or other chemistries that may be susceptible to thermal runaway. In at least one embodiment, the battery 100 includes a lithium-ion battery cell. The battery 100 may be a primary cell or a secondary cell. In other words, the battery 100 may or may not be rechargeable.

The housing 102 of the battery 100 may define a general shape and outer surface of the battery 102. Additionally, the housing 102 may protect the battery 100 from damage and ingress of foreign material. The housing 102 of the battery 100 may include any suitable resilient material or materials. Resilient (e.g., resistant to puncture and corrosion and chemically stable) material or materials may be configured to protect the internal components (e.g., the anode electrode 106, the cathode electrode 108, the separator 104, the electrolyte 112, etc.) of the battery 100. Such resilient materials may include, for example, nickel, steel, titanium, aluminum, or other resilient materials. Packaging may include any suitable packaging material or materials for holding internal components of the battery 100 together in a predefined shape. Such packaging materials may include, plastic, ceramics, etc.

The anode electrode 106 may include any suitable material or materials. Such materials may include, for example, one or more active materials, conductive materials, binders, or other suitable anode materials. Active material of the anode electrode 106 may include, for example, one or more of carbon, graphite, silicon, lithium titanates, lithium, sodium, magnesium, or other negative active. Conductive materials of the anode electrode 106 may include, for example, copper, gold, carbon, nickel, carbon black, graphene, carbon nanotubes, or other conductive materials. Binders of the anode electrode 106 may include, for example, polyvinylidene fluoride (PVDF), poly(vinylidene fluoride-co-hexafluoropropylene) (PVDF-HFP), styrene-butadiene rubber (SBR), carboxymethyl cellulose (CMC), or other materials for binding anode materials together.

The cathode electrode 108 may include any suitable material or materials. Such materials may include, for example, one or more active materials, conductive materials, binders, gelled electrolyte, or other cathode materials. Active material of the cathode electrode 108 may include, for example, carbon fluoride, silver vanadates, lithium vanadates, manganese dioxide, vanadium dioxide, lithium cobalt oxide, lithium nickel-manganese-cobalt oxide, lithium nickel-cobalt-aluminum oxide, other positive active materials, or any combination thereof. In one or more embodiment, the active material of the cathode includes carbon fluoride and silver vanadium oxide. Conductive materials of the cathode electrode 108 may include, for example, copper, gold, carbon, nickel, carbon black, graphene, carbon nanotubes, or other conductive materials. Binders of the cathode electrode 108 may include, for example, polyvinylidene fluoride (PVDF), poly(vinylidene fluoride-co-hexafluoropropylene) (PVDF-HFP), styrene-butadiene rubber (SBR), carboxymethyl cellulose (CMC), poly(tetrafluoroethylene) (PTFE), or other material for binding cathode materials together.

The electrodes 106, 108 may take on any suitable shape and may be provided or arranged in any suitable manner. The electrodes 106, 108 may be provided as relatively flat or planar plates or may be wrapped or wound in a spiral or other configuration (e.g., an oval configuration). The electrodes 106, 108 may also be provided in a folded configuration.

The separator 104 may be arranged between the anode electrode 106 and the cathode electrode 108. The separator 104 may be configured to prevent direct contact between the anode electrode 106 and the cathode electrode 108. The separator 104 may further be configured to allow transport of ionic charge carriers between the anode electrode 106 and the cathode electrode 108.

The separator 104 may take on any suitable size or shape. The separator 104 may be, for example, flat, planar, wrapped or wound in a spiral, elliptical, folded, or any other suitable shape for being arranged between the anode electrode 106 and the cathode electrode 108. In general, the size and shape of the separator 104 may be dependent on or conform to the size and shape of the electrodes 106, 108. For example, the separator 104 may be provided as relatively flat or planar when the electrodes 106, 108 are provided as planar plates. Further, for example, the separator 104 may be provided in a wound configuration to separate the electrodes 106, 108 when such electrodes are provided in a wound or spiral configuration.

The separator 104 may be designed to withstand multiple exposures to temperatures of greater than 100 degrees Celsius with little to no degradation. Not wishing to be bound by theory, it is thought that the separator 104 may not need to include a material that has a degradation temperature degradation temperature equal to or greater than the highest temperature that the battery is intended to be exposed to. The term “degradation temperature” is the temperature at which a material is no longer mechanically and/or chemical stable. In some embodiments, the degradation temperature is the melting temperature of the material. It is thought that although the battery may be exposed to a certain high exposure temperature, the separator 104 within the battery may be at least partially insulated and as such, reach a lower temperature than the exposure temperature.

In some embodiments, the separator 104 includes two or more layers. The two or more layers may be bound together (e.g., laminated), to from a single multi-layer composite separator. Each layer of a composite separator may have the same degradation temperature. Each a layer of the composite separator may have different degradation temperature. Two or more of the layers of the separator 104 may have the same degradation temperature while one or more other layers may have different degradation temperatures.

In some embodiments, the separator 104 includes one or more layers that have a degradation temperature of 100 degrees Celsius or greater, preferably 125 degrees Celsius or greater. In some embodiments, the separator 104 includes one or more layers that have a degradation temperature of 100 degrees Celsius or greater, 125 degrees Celsius or greater, 135 degrees Celsius or greater, 150 degrees Celsius or greater, 160 degrees Celsius or greater, 170 degrees Celsius or greater, 180 degrees Celsius or greater, or 200 degrees Celsius or greater. There is no desired upper limit to the degradation temperature of a layer included in a separator 104; however, in practice, the separator 104 may include one or more layers having a degradation temperature of 300 degrees Celsius or less. In embodiments, the separator 104 includes one or more materials having a degradation temperature of 100 degrees Celsius to 300 degrees Celsius, 125 degrees Celsius to 300 degrees Celsius, 150 degrees Celsius to 300 degrees Celsius, or 180 degrees Celsius to 300 degrees Celsius.

In some embodiments, multiple separator layers may be used, each of which may have a melting point 100 degrees Celsius or greater, preferably 125 degrees Celsius or greater. In some embodiments, one or more of the layers of a composite separator may have a lower degradation temperature such that it melts when exposed to an elevated temperature. Such a layer sandwiched between two or more layers that have degradation temperatures above the elevated exposure temperature may serve the purpose of a shutdown separator. For example, a composite separator may include three layers. The inner layer may have a degradation temperature that is lower than the anticipated elevated temperature that the battery 100 and/or separator 104 will be exposed to. The two outer layers may have degradation temperatures that are greater than the anticipated elevated exposure temperature that the battery 100 and/or separator 104 will be exposed to. Upon exposure of the battery to an elevated exposure temperature, the inner layer of the composite separator may melt, preventing ion flow in the battery while maintaining the separation between the anode and the cathode. An example of such a composite separator configuration includes a separator that has an inner layer material with a degradation temperature of approximately 130 degrees Celsius and two outer layers having a degradation temperature 200 degrees Celsius or greater. Such separators may include a polyethylene inner layer and polypropylene outer layers such as the separator 104s available from CELGARD (Charlotte, NC) under the trade name CELGARD TRILAYER PP/PE/PP.

The separator 104 may include any suitable separator material. Examples of suitable separator materials include, polymeric porous membranes such as polyethylene, polypropylene, polyethylene terephthalate, polyimide, cellulose based polymers and combinations thereof; modified polymeric membranes with thin oxide/nitride coatings of boehmite (AIOOH), alumina (Al₂O₃), aluminum nitride (AlN), titania (TiO₂), zinc oxide (ZnO), silica (SiO₂), and combinations thereof; and hybrid organic-organic assemblies such as those that contain SiO₂ nanoparticles covalently tethered within a polymeric network such as polyurethanes, polyacrylates, polyethylene glycol; and combinations thereof.

In some embodiments, the separator material is a material that has a degradation temperature of 125 degrees Celsius or greater. Examples of such materials include polyimides, polyolefins (e.g., polypropylene), polyethylene terephthalate, ceramic-coated polymer (e.g., ceramic coated polypropylene and ceramic coated polyethylene), cellulose, and combinations thereof. Such materials may be in the form in microfibers, nanofibers, or both. In some embodiments, the separator 104 includes a combination of microfibers and nanofibers. In some embodiments, the separator includes polyethylene terephthalate microfibers and cellulose nanofibers. Examples of such separators are disclosed in U.S. Pat. No. 8,936,878 and are available from Dreamweaver International (in Greer, SC) under the tradename SILVER, TITANIUM, and GOLD.

Examples of separator materials that have a degradation temperature of 200 degrees Celsius or greater include polyimide, polyethylene terephthalate, cellulose, aramid fibers, ceramics, and combinations thereof.

The separator 104 may define a membrane forming a microporous layer. The separator 104 may include any suitable material or materials. The separator 104 may include, for example, one or more of a polymer, polyethylene, polypropylene, polyimide, cellulose, or other materials for forming a microporous layer. The microporous layer formed by the separator 104 may permit ions to pass through the separator 104 to allow ions to move between the electrodes 106, 108.

During charging and discharging of the battery 100, ions move between the anode electrode 106 and the cathode electrode 108. For example, when the battery 100 is charged, lithium ions flow from the cathode electrode 108 to the anode electrode 106. In contrast, when the battery 100 is discharged, ions flow from the anode electrode 106 to the cathode electrode 108.

The solution 110 may provide a medium for ions to move between the electrodes 106, 108. The electrolyte 112 may transport positively charged ions between the anode electrode 106 and the cathode electrode 108. The electrolyte 112 may include any suitable material or materials. The electrolyte 112 may include one or more solutes. Solutes of the electrolyte 112 may include, for example, lithium salts such as lithium bis(trifluoromethanesulfonimide) (LiTFSI); lithium bis(oxalate)borate (LiBOB); lithium difluoro(oxalato)borate (LiDFOB); lithium bis(pentafluoroethyl sulfonyl)imide (LiBETI); lithium bis(fluorosulfonyl)imide (LiFSI), lithium difluoro(oxalate)borate (LiDFOB); lithium tetrafluoroborate (LiBF₄); bis(perfluoroethanesulfonyl)imide (LiPFSI or LiBETI); lithium-cyclo-difluoromethane-1,1-bis(sulfonyl)imide (LIDMSI); lithium trifluoromethanesulfonate (lithium triflate); lithium fluoroalkyphosphate (LiFAP); lithium-cyclo-hexafluoropropane-1,1-bis(sulfonyl)imide (LiHPSI); lithium hexafluoroarsenate (LiAsF₆); lithium hexafluorophosphate (LiPF₆); lithium dicyano-trifluoromethyl-imidazole (LiTDI); lithium bis(fluoromalonato)borate (LiNFMB); dilithium tetracyanoborate; lithium dicyanotriazlate (LiDCTA); cyano-pentafluoroethyl-imidazole; lithium perchlorate; any combinations thereof; or other solute capable of transporting ionic charge carriers.

In some embodiments, the electrolyte 112 includes one or more organic solvents. Examples of organic solvents include linear carbonates such as ethylmethyl carbonate (EMC), dimethyl carbonate (DMC), diethyl carbonate (DEC); ethers such as 1,2,-diethoxyethane (DME); linear carboxylic esters such as methyl formate, methyl acetate, and methyl propionate; nitriles such as acetonitrile; cyclic carbonates such as butylene carbonate (BuC), ethylene carbonate (EC); phenylene carbonate (PeC), hexylene carbonate (HeC), octylene carbonate (OcC), and dodecylene carbonate (DoC); organo sulfur compounds such as sulfolane (SL); and combinations thereof. Organic solvents that have high boiling points tend to have increased viscosities which may result in lower ionic conductivity. As such, in some embodiments, the organic solvent of the electrolyte 112 includes at least one solvent having a boiling point below 140 degrees Celsius. Examples of such solvents include some linear carbonates such as 1,2-diethyoxyethane; some linear carboxylic esters such as methyl formate, methyl acetate, ethyl acetate, and methyl propionate; and some nitriles such as acetonitrile.

In some embodiments, the organic solvent includes a mixture of ethylene carbonate (EC) and ethylmethyl carbonate (EMC). In some embodiments, the organic solvent includes a mixture EC and EMC in a range of 10:90 to 50:50. In some embodiments, the organic solvent includes a mixture of EC and EMC in a ratio of 30:70.

In some embodiments, the organic solvent includes a mixture of EC, EMC, and sulfolane (SL). In some embodiments, the organic solvent includes a mixture of EC, EMC and SL in a weight ratio of 20:70:10.

In some embodiments, the electrolyte 112 includes one or more electrolyte additives. Typically, an electrolyte additive enables a higher voltage operation (e.g., greater than 4.2 V), but can also be used at lower voltages (e.g., less than 4.2 V) and at elevated temperatures (e.g., temperatures greater than 100 degrees Celsius). The electrolyte additives may include unsaturated compounds such as vinylene carbonate (VC) or vinyl ethylene carbonate (VEC); sulfur-containing compounds such as 1,3-propane sultone (PS), prop-e-ene 1,3-sultone (PES), 1,3,2-dioxthiolane-2-2dioxide (DTD), trimethylene sulfate (TMS), methylene methyl disulfonate (MMDS); boron-containing compounds such as trimethylboroxine and trimethoxyboroxine (TMOBX); phosphorous-containing compounds such as tris(1,1,1,3,3,3-hexafluoro-2-isopropyl)phosphate (HFiP), tris(trimethylsilyl) phosphate (TTSP), tris(trimethylsilyl) phosphite (TTSPi), triallyl phosphate (TAP); aromatic compounds such as biphenyl (BP); heterocyclic compounds such as thiophene (TP); Lewis acid-base adducts such as pyridine-boron trifluoride (PBF); 2,4,6,8-tetramethyl-2,4,6,8-tetravinylcyclotetra-siloxane (ViD4); and mixtures thereof.

When activated, the shutdown initiator 114 may inhibit ion transport between the electrodes 106, 108. Activation of the shutdown initiator 114 may occur in response to a temperature of the battery 100 exceeding a threshold temperature or activation temperature. The threshold temperature may depend on a particular use case of the battery. For example, it may be desirable for batteries used in medical tools to remain functional after an autoclave sterilization process. Accordingly, the threshold temperature may be greater than typical autoclave temperatures. In general, the threshold temperature may be in a range of at least 140 degrees Celsius to no greater than 220 degrees Celsius or any range therebetween. In some embodiments, the threshold temperature may be at least 150 degrees Celsius.

In some embodiments, the threshold temperature is 140 degrees Celsius or greater, 150 degrees Celsius or greater, 160 degrees Celsius or greater, 170 degrees Celsius or greater, 180 degrees Celsius or greater 190 degrees Celsius or greater, 200 degrees Celsius or greater, or 210 degrees Celsius or greater. In some embodiments, the threshold temperature is 220 degrees Celsius or less, 210 degrees Celsius or less, 200 degrees Celsius or less, 190 degrees Celsius or less, 180 degrees Celsius or less, 170 degrees Celsius or less, 160 degrees Celsius or less or 150 degrees Celsius or less. In some embodiments, the threshold temperature is 150 degrees Celsius to 220 degrees Celsius, 150 degrees Celsius to 200 degrees Celsius, 150 degrees Celsius to 190 degrees Celsius, 150 degrees Celsius to 180 degrees Celsius, 150 degrees Celsius to 170 degrees Celsius or 150 degrees Celsius to 160 degrees Celsius.

The shutdown initiator 114 may include an oxidizing agent. An oxidizing agent is a chemical species capable of oxidizing a compound, atom, or ion. “Oxidation” and its grammatical equivalents refer to the loss of electrons, gain of one or more oxygen atoms, loss of one or more hydrogen atoms, or any combination thereof, from a compound, atom, or ion. The loss of electrons can be in the form of a new chemical bond (ionic or covalent) between two or more compounds, atoms, or ions. In some cases, the gain of one or more oxygen atoms also results in the loss of electrons. For example, the rusting of iron (2Fe(s)+3O₂(g)→2(Fe₂O₃) (s)) involves iron loosing electrons to oxygen and the formation of new chemical bonds between iron and oxygen (gain of oxygen).

The oxidizing agent may oxidize one or more components of the electrolyte 112. Oxidation of one or more components of the electrolyte 112 may decrease ion transfer efficiency thereby inhibiting ion transfer between the electrodes.

The shutdown initiator 114 may include one or more oxidizing agents. In some embodiments, the one or more oxidizing agents are selected to oxidize the solvent compounds of the electrolyte 112. In some embodiments, the one or more oxidizing agents are selected to oxidize the solutes of the electrolyte 112. In some embodiments, the one or more oxidizing agents are selected to oxidize the solvent compounds and the solutes of the electrolyte 112.

Examples of suitable oxidizing agents include peroxides such as hydrogen peroxide (H₂O₂), perborate ([B(OH)₂OO)₂]⁻²), peracetic acid (CH₃CO₂H), benzoyl peroxide, and persulfate ((S₂O₈)₂₋); permanganic acid (HMnO₄) and the permanganate ion (MnO₄²⁻); chromic acid (H₂CrO₄) and oxyanions of chromium such as the chromate ion (CrO4²⁻) and the dichromate anion (Cr₂O7²⁻); osmium tetroxide (OsO₄); nitric acid (HNO₃); chloric acid (ClO3H) and ions thereof such as chlorate (ClO₃⁻); hypochlorous acid (HOCl), ions thereof such as hypochlorite (ClO), and hypochlorite esters; and any combination thereof. The shutdown initiator may include the salt form of an oxidizing agent. For example, the shutdown initiator may include ammonium persulfate ((NH₄)₂S₂O₈); sodium perborate (NaH₂BO₄); sodium percarbonate (Na₂H₃CO₆); sodium permanganate (NaMnO₄); potassium persulfate (2KS₂O₈); barium permanganate (Ba(MnO₄)₂); calcium permanganate (Ca(MnO₄)₂); silver permanganate (AgMnO₄); ammonium permanganate (NH4MnO4); sodium chromate (Na₂CrO₄); potassium chromate (K₂CrO₄); calcium chromate (CaCrO₄); ammonium chromate ((NH₄)₂(CrO₄); sodium dichromate (Na₂Cr₂O₇); potassium dichromate (K₂Cr₂O₇); calcium dichromate (CaCr₂O₇) ammonium dichromate (NH₄)₂Cr₂O₇)); sodium chlorate (NaClO₃); potassium chlorate (KClO₃); calcium chlorate (Ca(ClO3)2); calcium hypochlorite (Ca(ClO3)2); sodium hypochlorite (NaCIO); potassium hypochlorite (KClO); hydrates thereof; and any combination thereof.

In some embodiments, the shutdown initiator 114 includes a halogenating agent. In some such embodiments, the halogenating agent is an oxidizing agent. As used herein, a halogenating agent is a compound or ion that is capable of reacting with a target compound or target ion to create a chemical bond (ionic or covalent) between a halogen (F, Cl, Br, or I) of the halogenating agent and the target compound or target ion. The halogenating agent can be a fluorinating agent, a chlorinating agent, a brominating agent, an iodinating agent, or any combination thereof.

In some embodiments, the halogenating agent is a fluorinating agent. Without wishing to be bound by theory, it is thought that excessive fluorination of non-aqueous electrolyte 112 components can result in reduced ionic conductivity of the electrolyte 112 thereby resulting in inhibition of ion transfer between electrodes. For example, lithium cations may react with a fluorinating agent to form lithium fluoride, a salt that may not be soluble in the electrolyte. Precipitation of the lithium fluoride removes soluble lithium from the electrolyte thereby decreasing the ionic conductivity of the electrolyte. Examples of fluorinating agents include hydrogen fluoride (HF); silver fluoride (AgF); cobalt trifluoride (CoF₃); xenon difluoride (XeF₂); perchloryl fluoride (FCO₃); antimony trifluoride (SbF₃); arsenic trifluoride (AsF₃); bismuth pentafluoride (BiF₅); bromine pentafluoride (BrF₅); diethylaminosulfur trifluoride (SF₃N(CH₂CH₃)₂); vanadium fluoride (VF₅); nitrogen based fluorinating agents such as N-fluoropyridinium triflate and N-fluorobenzenesulphonimide; salts thereof (where appropriate); hydrates thereof (where appropriate); and any combination thereof.

In some embodiments the shutdown initiator 114 may include a gelling agent. As used herein, a gelling agent is a compound or combination of compounds that are capable of inducing and/or participating in a reaction with a monomer to produce a reaction product that is insoluble in the solution 110 or the electrolyte 112. For example, a gelling agent may be capable of inducing a polymerization reaction that results in one or more polymer chains that are not soluble in the solution 110 or the electrolyte 112. The polymer chains and/or the monomer reaction products can precipitate and/or aggregate to form a solid or a semi-solid (gel). The solid or semi-solid may inhibit ion transfer between the electrodes.

Polymerization may refer to a chemical reaction in which two or more compounds (called monomers) combine to form a larger molecule (polymer). The polymer includes repeating structural units derived from the monomers. In some embodiments, the gelling agent is capable of inducing polymerization of electrolyte solvent molecules (i.e., the monomers of the polymerization reaction).

The gelling agent may be selected based on the identity of the intended monomers (e.g., the electrolyte solvent). The type of monomer can influence the particular type of polymerization reaction thereby influencing the type of gelling agent that is able to indue the intended polymerization reaction. For example, monomers may be polymerized using chain growth methods or step growth methods. Examples of chain group methods include addition polymerization techniques and examples of step growth methods include condensation polymerization techniques. Examples of addition polymerization techniques include free radical polymerization such as reversible deactivation radical polymerization, atom transfer radical polymerization, reversible addition-fragmentation chain transfer polymerization, stable free radical polymerization; and ionic polymerization such as anionic polymerization and cationic polymerization. In some embodiments, a gelling agent is included in the reservoir that is capable of initiating an addition type polymerization. In other embodiments, a gelling agent is included in the reservoir 116 that is capable of initiating a condensation type polymerization.

In some embodiments, the shutdown initiator 114 includes a gelling agent capable of inducing ring opening polymerization of ring-containing electrolyte solvent monomers (e.g., ethylene carbonate, butylene carbonate, phenylene carbonate, hexylene carbonates, octylene carbonate, dodecylene carbonate, and sulfolane). Ring opening polymerization may occur via chain growth polymerization such as anionic ring-opening polymerization, cationic ring-opening polymerization, ring-opening metathesis, radical ring opening polymerization, coordination-insertion polymerization, amongst other mechanisms.

Each type of polymerization may be initiated by different types of initiators (e.g., gelling agents). For example, radical polymerization techniques are often initiated by a radical; cationic polymerization techniques are often initiated by electrophilic compounds and/or acids; anionic polymerization techniques are often initiated by an anion and/or nucleophile; and step-growth and/or condensation polymerization are often initiated by nucleophiles, anions, and/or cations. In some cases, the initiator is formed in situ from pre-initiator compounds. Example initiators that may be used as gelling agents include, lithium halides (e.g., LiI); compounds able to form free radicals such as peroxides (e.g., benzoyl peroxide and tert-butyl peroxide) and azo compounds (e.g., 2,2,′-azo-bis-isobutrylnitrile, AIBN); halohydric acids (e.g., HCl and HBr); Lewis acids (e.g., AlCl₃, SnCl₄, TiCl₄, AgClO₄, SbCl₅, and I₂); compounds that can from cations (e.g., t-butyl chloride, triphenylmethyl fluoride); alcohols; alkoxides; hydroxides; amines; phosphines; oganometal compounds such as organolithium (e.g., butyl lithium) and organomagnesium compounds; Grignard reagents; tin alkoxides (e.g., tributyltin methoxide, Bu₃SnOMe); salts thereof (were appropriate); or any combination thereof.

In some embodiments, the shutdown initiator 114 includes two or more gelling agents. In some such embodiments, the gelling agents that cooperatively function to induce polymerization of the solvent molecules. For example, in some embodiments, the shutdown initiator includes a Lewis acid (e.g., AlCl₃, SnCl₄, TiCl₄, AgClO₄, SbCl₅, and I₂) and a compound that can form cations (e.g., t-butyl chloride and triphenylmethyl fluoride).

In some embodiments, the shutdown initiator 114 includes one or more additives that facilitate the polymerization reaction. Example additives include catalysts and chain transfer reagents. An example catalyst is tin(II) 2-ethylhexanoate (Sn(Oct)₂). In some embodiments, the shutdown initiator includes an alcohol and/or an alkoxide and Sn(Oct)₂.

In some embodiments, the battery includes a reservoir 116 disposed in the housing 102. The reservoir may include the shutdown initiator 114 and a barrier 118. The barrier 118 may be disposed between the shutdown initiator 114 and the solution 110 to separate the shutdown initiator 114 from the solution 110. Furthermore, the barrier 118 may be configured to release the shutdown initiator 114 into the solution in response to a temperature of the barrier 118 exceeding the threshold temperature. In some embodiments, the barrier 118 may be configured to become permeable to the shutdown initiator 112 in response to the temperature of the barrier 118 exceeding the threshold temperature. In some embodiments, the barrier 118 may be configured to dissolve in response to the temperature of the barrier exceeding the threshold temperature.

The barrier 118 may include any suitable material or materials that allow or facilitate release of the shutdown initiator 112 in response to the temperature of the barrier 118 exceeding the threshold temperature. The barrier 118 may include, for example, polypropylene; polyethylene (PE); nylon; polyvinylidene fluoride (PVDF); polyvinyl chloride (PVC); acrylonitrile butadiene styrene (ABS); acetal, acrylic, cellulose acetate butyrate (CAB); polystyrene; poly(methylmethacrylate); and any combination thereof. In some embodiments, the barrier includes polypropylene.

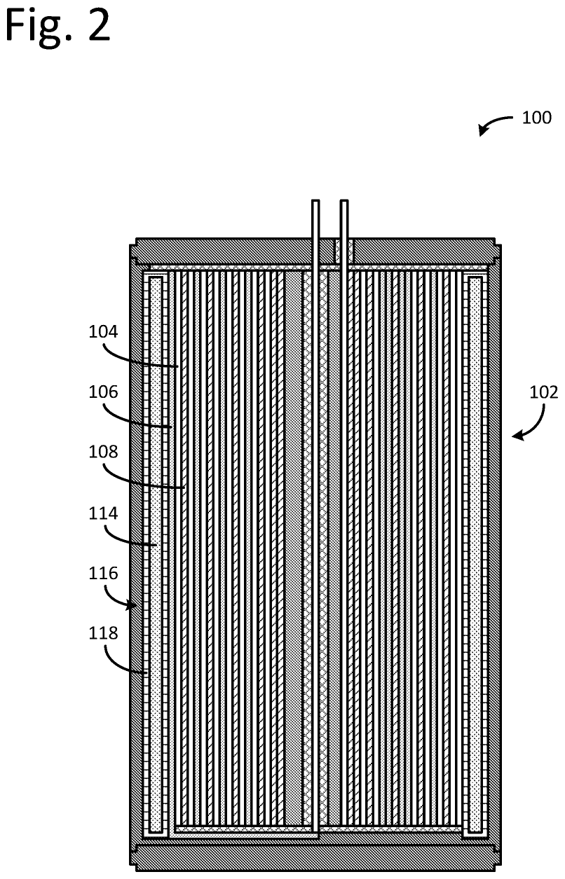

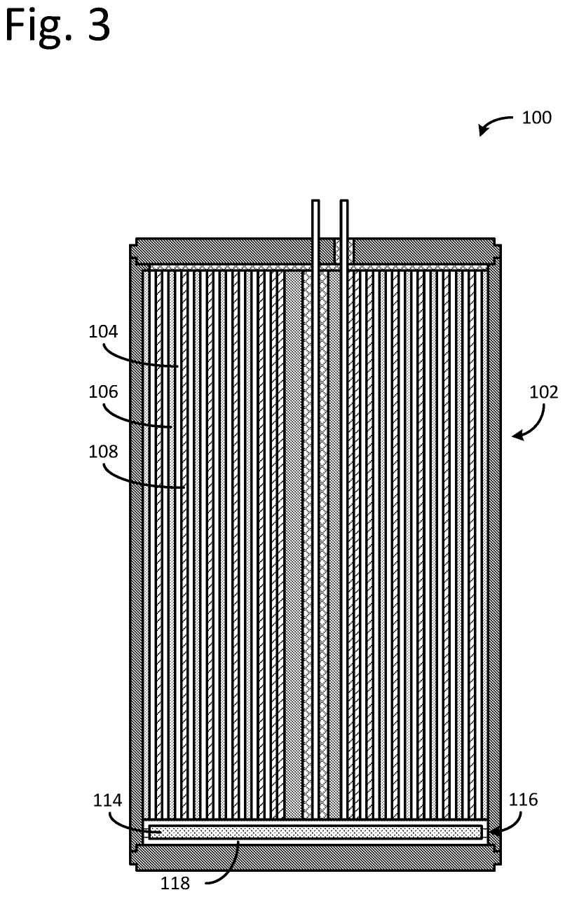

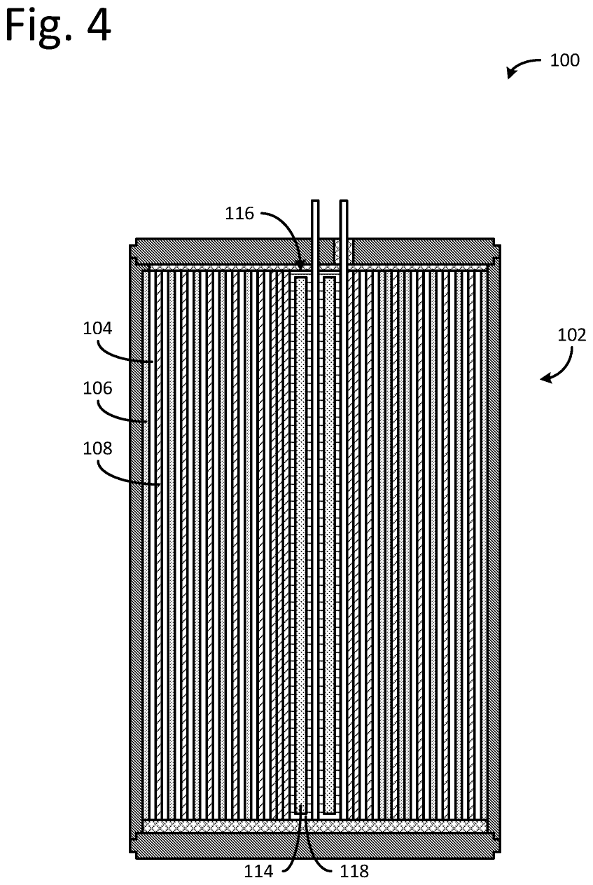

The reservoir 116 may take on any suitable shape or shapes. In general, the shape of the reservoir 116 may be defined by an outer surface of the barrier 118. The reservoir 116 may take on the shape of one or more beads, a cylinder, a polyhedron, etc. Additionally, the reservoir 116 may be incorporated into any suitable portion of the battery 102. In some embodiments, the reservoir 116 may define one or more beads in the solution 110 as shown in FIG. 1. In some embodiments, the reservoir 116 may be incorporated into a case liner of the battery 100 as depicted in FIG. 2. In some embodiments, the reservoir may be positioned between a cap or end of the housing 102 as depicted in FIG. 3. In some embodiments, the reservoir 116 may define a core of the battery 100 as depicted in FIG. 4. Although depicted as cylindrical cell batteries in FIGS. 2-4 the battery 100 may take on any suitable battery type or shape.

In some embodiments, the reservoir 116 includes a carrier. In some such embodiments, at least a portion of the shutdown initiator 114 is dissolved in the carrier. The carrier may be any solvent or mixture of solvents that does not adversely interact with the shutdown initiator 114; the components of the solution 110 or electrolyte 112; and/or material of the barrier 118. In some embodiments, the carrier may be a gelling agent. Examples of carriers include water, n-methylpyrrolidine, methanol, ethanol, dimethylformamide, tetrahydrofuran, ethyl acetate, isopropanol, chloroform, dimethyl sulfoxide, and any combinations thereof.

In some embodiments, the reservoir 116 does not include a carrier. In some such embodiments, the shutdown initiator is a liquid. In other such embodiments, the shutdown initiator is a solid.

In some embodiments, the solution 110 may include a reactant configured to react with the shutdown initiator 114 to inhibit ion transport between the cathode electrode 108 and the anode electrode 106. In some embodiments, the shutdown initiator 114 may be configured to react with the electrolyte 112 to inhibit ion transport between the cathode electrode 108 and the anode electrode 106. In other embodiments, the shutdown initiator 114 may be configured to react with other components of the solution 110 to inhibit ion transport between the cathode electrode 108 and the anode electrode 106. For example, the solution 110 may include a monomer 120 and the shutdown initiator 114 may be configured to cause polymerization of the monomer 120 when the shutdown initiator 114 is released into the solution 110.

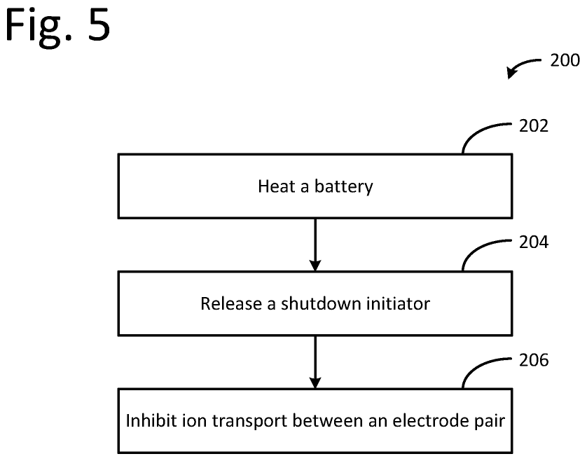

FIG. 5 shows a flow diagram of a method or process 200 for inhibiting ion transfer of a battery (e.g., the battery 100 of FIG. 1). Although described in regard to the battery 100, the method 200 may be carried out using any suitable battery.

At 202, the battery 100 may be heated above a threshold temperature. The battery 100 may be heated above the threshold temperature by ambient conditions or a battery failure. For example, the battery may be used in sensor used in industrial conditions that exceed the threshold temperature. Further, for example, the battery 100 may become shorted due to physical damage or other conditions causing the battery 100 to generate heat and exceed the threshold temperature.

At 204, the shutdown initiator 114 may be released into the solution 110 in response to the temperature of the battery exceeding the threshold temperature. The shutdown initiator 114 may be released into the solution 110 when the barrier 116 exceeds the threshold temperature. The barrier 116 may dissolve, become permeable, or otherwise allow the shutdown initiator 114 to flow into the solution 110.

At 206, ion transport between the electrode pair 106, 108 may be inhibited using the shutdown initiator 114 in response to the shutdown initiator 114 being released into the solution 110. In some embodiments, inhibiting ion transport between the electrode pair 106, 108 may include inducing a fluorination reaction with the solution 110 using the shutdown initiator 114. In some embodiments, inhibiting ion transport between the electrode pair 106, 108 may include inducing an oxidation reaction with the solution 110 using the shutdown initiator 114. In some embodiments, inhibiting ion transport between the electrode pair 106, 108 may include gelling the solution 110 using the shutdown initiator. In some embodiments, inhibiting ion transport between the electrode pair 106, 108 may include inducing a ring-opening reaction with the solution 110 using the shutdown initiator 114.

The invention is defined in the claims. However, below there is provided a non-exhaustive list of non-limiting examples. Any one or more of the features of these examples may be combined with any one or more features of another example, embodiment, or aspect described herein.

### Examples Section to be Completed After First Draft Review

All scientific and technical terms used herein have meanings commonly used in the art unless otherwise specified. The definitions provided herein are to facilitate understanding of certain terms used frequently herein and are not meant to limit the scope of the present disclosure.

As used herein, singular forms “a,” “an” and “the” include plural referents unless the context clearly dictates otherwise. As used in this specification and the appended claims, the term “or” is generally employed in its sense including “and/or” unless the content clearly dictates otherwise. The term “and/or” means one or all of the listed elements or a combination of any two or more of the listed elements.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

The following examples are a non-limiting list of clauses in accordance with one or more techniques of this disclosure.

Example 1. A battery comprising: a housing; an electrode assembly disposed in the housing, the electrode assembly comprising: a cathode electrode; an anode electrode; and a separator arranged between the cathode electrode and the anode electrode, the separator configured to prevent direct contact between the anode electrode and the cathode electrode; a solution disposed in the housing and comprising an electrolyte to facilitate ion transport between the cathode electrode and the anode electrode; a reservoir disposed in the housing, the reservoir comprising: a shutdown initiator to inhibit ion transport between the cathode electrode and the anode electrode upon contact with the solution; and a barrier disposed between the shutdown initiator and the solution to separate the shutdown initiator from the solution, the barrier configured to release the shutdown initiator into the solution in response to a temperature of the barrier exceeding a threshold temperature.

Example 2. The battery as in Example 1, wherein the threshold temperature is at least 150 degrees Celsius.

Example 3. The battery as in Example 1, wherein the shutdown initiator comprises an oxidizing agent.

Example 4. The battery as in Example 1, wherein the oxidizing agent comprises a fluorinating agent.

Example 5. The battery as in Example 1, wherein the shutdown initiator comprises a gelling agent.

Example 6. The battery as in Example 1, wherein the shutdown initiator comprises a gelling agent that induces a ring-opening reaction upon contact with the solution.

Example 7. The battery as in Example 1, wherein the solution comprises a monomer and the shutdown initiator is configured to cause polymerization of the monomer when the shutdown initiator is released into the solution.

Example 8. The battery as in Example 1, wherein the solution further comprises a reactant configured to react with the shutdown initiator to inhibit ion transport between the cathode electrode and the anode electrode.

Example 9. The battery as in Example 1, wherein the shutdown initiator is configured to react with the electrolyte to inhibit ion transport between the cathode electrode and the anode electrode.

Example 10. The battery as in Example 1, wherein the barrier comprises polypropylene.

Example 11. The battery as in Example 1, wherein the reservoir defines a core of the battery.

Example 12. The battery as in Example 1, wherein the barrier is configured to become permeable by the shutdown initiator in response to the temperature of the barrier exceeding the threshold temperature.

Example 13. The battery as in Example 1, wherein the barrier is configured to dissolve in response to the temperature of the barrier exceeding the threshold temperature.

Example 14. A battery comprising: a housing; an electrode assembly disposed in the housing, the electrode assembly comprising: a cathode electrode; an anode electrode; and a separator arranged between the cathode electrode and the anode electrode, the separator configured to prevent direct contact between the anode and the electrode; a solution disposed in the housing and comprising an electrolyte to facilitate ion transport between the cathode electrode and the anode electrode; and a shutdown initiator disposed in the housing to inhibit ion transport between the cathode electrode and the anode electrode in response to a temperature of the battery exceeding a threshold temperature.

Example 15. The battery as in Example 14, further comprising a barrier disposed between the shutdown initiator and the solution to separate the shutdown initiator from the solution, the barrier configured to release the shutdown initiator into the solution in response to the temperature of the battery exceeding a threshold temperature.

Example 16. The battery as in Example 14, wherein the shutdown initiator is disposed in the solution contact with the solution and remains inert in the solution below the threshold temperature.

Example 17. The battery as in Example 14, wherein the threshold temperature is at least 150 degrees Celsius.

Example 18. The battery as in Example 14, wherein the shutdown initiator comprises a fluorinating agent.

Example 19. The battery as in Example 14, wherein the shutdown initiator comprises an oxidizing agent.

Example 20. The battery as in Example 14, wherein the shutdown initiator comprises a gelling agent.

Example 21. The battery as in Example 14, wherein the shutdown initiator is configured to react with the electrolyte to inhibit ion transport between the cathode electrode and the anode electrode in response to the temperature of the battery exceeding the threshold temperature.

Example 22. The battery as in Example 14, wherein the shutdown initiator defines a core of the battery.

Example 23. A method comprising: heating a battery above a threshold temperature, wherein the battery comprises: a housing; an electrode assembly disposed in the housing and comprising an electrode pair; a solution disposed in the housing and comprising an electrolyte to facilitate ion transport between the electrode pair; a reservoir disposed in the housing, the reservoir comprising: a shutdown initiator; and a barrier disposed between the shutdown initiator and the solution; releasing the shutdown initiator into the solution in response to a temperature of the battery exceeding the threshold temperature; and inhibiting ion transport between the electrode pair using the shutdown initiator in response to the shutdown initiator being released into the solution.

Example 24. The method as in Example 23, wherein the threshold temperature is at least 150 degrees Celsius.

Example 25. The method as in Example 23, wherein inhibiting ion transport between the electrode pair comprises inducing a fluorination reaction with the solution using the shutdown initiator.

Example 26. The method as in Example 23, wherein inhibiting ion transport between the electrode pair comprises inducing an oxidation reaction with the solution using the shutdown initiator.

Example 27. The method as in Example 23, wherein inhibiting ion transport between the electrode pair comprises gelling the solution using the shutdown initiator.

Example 28. The method as in Example 23, wherein inhibiting ion transport between the electrode pair comprises inducing a ring-opening reaction with the solution using the shutdown initiator.

1-15. (canceled)

16. A battery comprising:
a housing;
an electrode assembly disposed in the housing, the electrode assembly comprising:
a cathode electrode;
an anode electrode; and
a separator arranged between the cathode electrode and the anode electrode, the separator configured to prevent direct contact between the anode electrode and the cathode electrode;
a solution disposed in the housing and comprising an electrolyte to facilitate ion transport between the cathode electrode and the anode electrode;
a reservoir disposed in the housing, the reservoir comprising:
a shutdown initiator to inhibit ion transport between the cathode electrode and the anode electrode upon contact with the solution; and
a barrier disposed between the shutdown initiator and the solution to separate the shutdown initiator from the solution, the barrier configured to release the shutdown initiator into the solution in response to a temperature of the barrier exceeding a threshold temperature.

17. The battery as in claim 16, wherein the threshold temperature is at least 150 degrees Celsius.

18. The battery as in claim 16, wherein the shutdown initiator comprises an oxidizing agent.

19. The battery as in claim 16, wherein the oxidizing agent comprises a fluorinating agent.

20. The battery as in claim 16, wherein the shutdown initiator comprises a gelling agent.

21. The battery as in claim 16, wherein the shutdown initiator comprises a gelling agent that induces a ring-opening reaction upon contact with the solution.

22. The battery as in claim 16, wherein the solution comprises a monomer and the shutdown initiator is configured to cause polymerization of the monomer when the shutdown initiator is released into the solution.

23. The battery as in claim 16, wherein the solution further comprises a reactant configured to react with the shutdown initiator to inhibit ion transport between the cathode electrode and the anode electrode.

24. The battery as in claim 16, wherein the shutdown initiator is configured to react with the electrolyte to inhibit ion transport between the cathode electrode and the anode electrode.

25. The battery as in claim 16, wherein the barrier comprises polypropylene.

26. The battery as in claim 16, wherein the reservoir defines a core of the battery.

27. The battery as in claim 16, wherein the barrier is configured to become permeable by the shutdown initiator in response to the temperature of the barrier exceeding the threshold temperature.

28. The battery as in claim 16, wherein the barrier is configured to dissolve in response to the temperature of the barrier exceeding the threshold temperature.

29. A battery comprising:
a housing;
an electrode assembly disposed in the housing, the electrode assembly comprising:
a cathode electrode;
an anode electrode; and
a separator arranged between the cathode electrode and the anode electrode, the separator configured to prevent direct contact between the anode and the electrode;
a solution disposed in the housing and comprising an electrolyte to facilitate ion transport between the cathode electrode and the anode electrode; and
a shutdown initiator disposed in the housing to inhibit ion transport between the cathode electrode and the anode electrode in response to a temperature of the battery exceeding a threshold temperature.

30. The battery as in claim 29, further comprising a barrier disposed between the shutdown initiator and the solution to separate the shutdown initiator from the solution, the barrier configured to release the shutdown initiator into the solution in response to the temperature of the battery exceeding a threshold temperature.

31. The battery as in claim 29, wherein the shutdown initiator is disposed in the solution contact with the solution and remains inert in the solution below the threshold temperature.

32. The battery as in claim 29, wherein the threshold temperature is at least 150 degrees Celsius.

33. The battery as in claim 29, wherein the shutdown initiator comprises a fluorinating agent.

34. The battery as in claim 29, wherein the shutdown initiator comprises an oxidizing agent.

35. The battery as in claim 29, wherein the shutdown initiator comprises a gelling agent.

36. The battery as in claim 29, wherein the shutdown initiator is configured to react with the electrolyte to inhibit ion transport between the cathode electrode and the anode electrode in response to the temperature of the battery exceeding the threshold temperature.

37. The battery as in claim 29, wherein the shutdown initiator defines a core of the battery.

38. A method comprising:
heating a battery above a threshold temperature, wherein the battery comprises:
a housing;
an electrode assembly disposed in the housing and comprising an electrode pair;
a solution disposed in the housing and comprising an electrolyte to facilitate ion transport between the electrode pair;
a reservoir disposed in the housing, the reservoir comprising:
a shutdown initiator; and
a barrier disposed between the shutdown initiator and the solution;
releasing the shutdown initiator into the solution in response to a temperature of the battery exceeding the threshold temperature; and
inhibiting ion transport between the electrode pair using the shutdown initiator in response to the shutdown initiator being released into the solution.

39. The method as in claim 38, wherein the threshold temperature is at least 150 degrees Celsius.

40. The method as in claim 38, wherein inhibiting ion transport between the electrode pair comprises inducing a fluorination reaction with the solution using the shutdown initiator.

41. The method as in claim 38, wherein inhibiting ion transport between the electrode pair comprises inducing an oxidation reaction with the solution using the shutdown initiator.

42. The method as in claim 38, wherein inhibiting ion transport between the electrode pair comprises gelling the solution using the shutdown initiator.

43. The method as in claim 38, wherein inhibiting ion transport between the electrode pair comprises inducing a ring-opening reaction with the solution using the shutdown initiator.
